(19) United States
(12) Patent Application Publication
(10) Pub. No.: US 2025/0357838 A1
(43) Pub. Date: Nov. 20, 2025

(54) Superconducting Motor with Spoke-Supported Heatshield

(71) Applicant: Hinetics, Inc., Champaign, IL (US)

(72) Inventors: Thanatheepan Balachandran, Savoy, IL (US); Kiruba S. Haran, Champaign, IL (US); Jianqiao Xiao, Champaign, IL (US)

(21) Appl. No.: 19/207,466

(22) Filed: May 14, 2025

Related U.S. Application Data
(60) Provisional application No. 63/647,944, filed on May 15, 2024.

(51) Int. Cl. H02K 55/00; H02K 1/24; H02K 5/08; H02K 5/10

(52) U.S. Cl. CPC H02K 55/00; H02K 1/24; H02K 5/08; H02K 5/10

(57) ABSTRACT

A lightweight superconducting machine suitable for aerospace applications provides a spoke-suspended heatshields reducing radiative transmission of heat to the superconducting coils within the heatshields. The heatshields are supported on insulating tensile spokes communicating with the central shaft reducing heat transfer therebetween.

### CROSS REFERENCE TO RELATED APPLICATION

This application claims the benefit of U.S. provisional application 63/647,944 filed May 15, 2024, and hereby incorporated by reference.

### STATEMENT REGARDING FEDERALLY SPONSORED RESEARCH OR DEVELOPMENT

N/A

### BACKGROUND OF THE INVENTION

The present invention relates to high-power-to-weight electric motors for aerospace applications, and in particular to a superconducting electric motor having a spoke supported heatshield.

Electric motors for aerospace applications, for example, for use in aircraft, desirably provide a high specific power, that is high power output with light weight. Currently produced wound-field synchronous motors can provide about two kilowatts of power per kilogram of weight with a nominal efficiency of about 90 percent. Recent advances using permanent magnets have achieved specific power in excess of 13 kilowatts per kilogram with efficiencies in excess of 96 percent; however, the fault tolerance of such permanent magnet systems has not been established.

Desirably, the permanent magnets of such electric motors could be replaced with superconducting coils to provide improved efficiency and lighter weight (greater specific power). The substantial demands of cryogenic cooling sufficient to cool such motors, however, present a significant challenge because of the weight, complexity, and bulk of such coolers and the necessary plumbing for fluids used for heat transfer between the motor and the cooler.

US Patent publications US 2022/0302816 and 2024/0014709, assigned to the assignee of the present application and hereby incorporated by reference, describe construction techniques for cryogenic electrical motors employing a spoke system for suspending the superconducting rotor magnets about the shaft while providing low thermal conduction between the shaft and the rotor magnets.

### SUMMARY OF THE INVENTION

The present inventors have identified a significant source of rotor heating in radiative transfer between the motor shaft and the rotor magnets. The present invention provides a heatshield system for reducing this radiative heat transfer without further promoting the transfer of heat from the shaft through the heatshield by suspending the heatshield on a separate spoke system. The shield may employ a dedicated cooler to better match the heat load and temperature of the shield.

More specifically, in one embodiment, the invention provides a superconducting machine having a stator and a rotor, the latter having a central shaft rotatably mounted with respect to a stator to allow the rotor to rotate about a shaft axis with respect to the stator. The rotor includes: a rotor shell attached to and thermally isolated from the shaft, a set of superconducting windings positioned on the rotor shell; and a heatshield positioned outside and surrounding the rotor shell to block radiative heat transfer and supported by and isolated from the shaft by a plurality of tensioned, flexible spokes.

It is thus a feature of at least one embodiment of the invention to provide a thermal radiation heatshield supported by the rotor to reduce radiative heat transfer from the rotor without promoting heat transfer through a mechanical connection path to the shield.

The first and second sets of the plurality of flexible spokes maybe disjoint with flexible spokes of the first set extending in parallel from the shaft to the respective rotor shell with respect to flexible spokes of the second set extending between the shaft and the heatshield.

It is thus a feature of at least one embodiment of the invention to minimize spoke number and heat transfer according to the lower mechanical forces on the shield.

The heatshield may provide a tubular extent along the length of the rotor shell received by end caps extending radially inwardly toward the central shaft to an opening surrounding but spaced from the central shaft; and wherein the second set of the plurality of flexible spokes are positioned between the opening and the central shaft.

It is thus a feature of at least one embodiment of the invention to provide support of the shield using structure of the heatshield to minimize the necessary length of the spokes and to provide improved lateral heat shielding.

The superconducting machine may further include a second heatshield positioned inside the rotor shell surrounding the shaft to block radiative heat transfer and supported on the end caps.

It is thus a feature of at least one embodiment of the invention to provide improved isolation of the rotor magnets both from heat external to the motor and conducted into the motor through the shaft.

The superconducting machine may further include a first cryocooler communicating along the first conductive path with the rotor shell and a second cryocooler communicating along a second conductive path with the heatshield.

It is thus a feature of at least one embodiment of the invention to better tailor the capacities and temperatures to the different structures of the rotor coils and heatshields for improved thermal isolation.

The first and second cryo-coolers maybe mounted coaxially with the central shaft and may be mounted coaxially at opposite ends of the central shaft.

It is thus a feature of at least one embodiment of the invention to provide an efficient method of integrating dual cryocoolers into the rotor for coil cooling and shielding.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a motor constructed according to the present invention including a stator and a concentrically rotating wound-field rotor within a vacuum envelope and also showing internal and external heatshields;

FIG. 2 is a partial cutaway perspective view of the motor of FIG. 1 showing conductive straps of a cryocooler and a spoke structure for supporting a rotor shell about the central driveshaft and further showing the outer heatshield position between the rotor shell and the vacuum envelope and an inner shield in fragment attached to the end walls of the outer shield; and

FIG. 3 is an end view of the motor shaft and heatshield showing the spokes support system.

### DETAILED DESCRIPTION OF THE PREFERRED EMBODIMENT

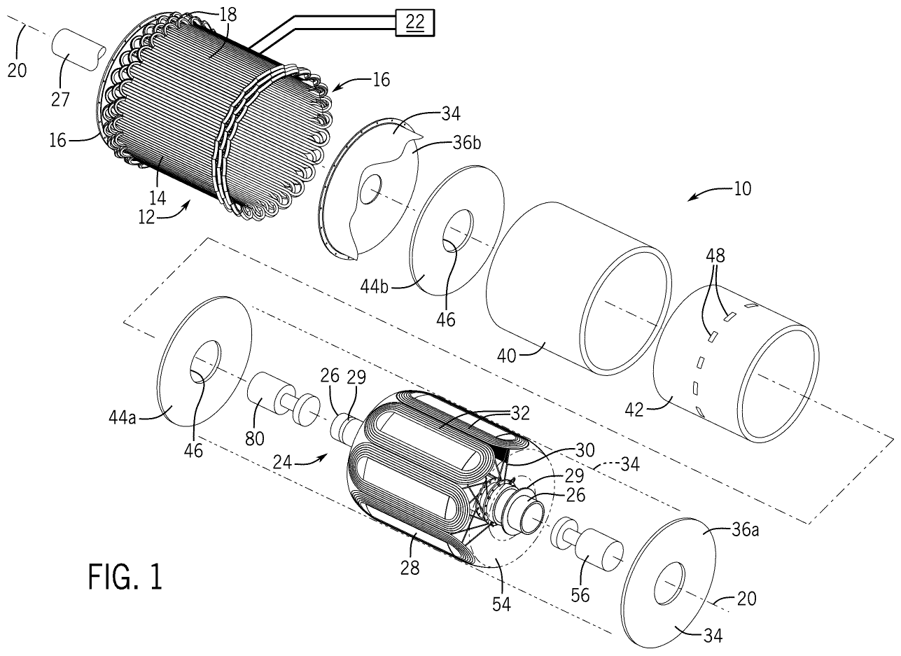

Referring now to FIG. 1, a superconducting motor 10 of the present invention may include a stator 12 providing, in one embodiment, a generally cylindrical, tubular stator form 14 having outwardly flared ends 16. A set of stator coils 18 may be attached to an inner surface of the stator form 14 spaced angularly about an axis 20 of the stator form 14 and extending between its opposite ends in a race-track shape. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

Fitting within the stator form 14 to rotate therein about the axis 20 is a rotor 24 providing a tubular rotor shaft 26 that may communicate beyond the confines of the motor 10 as a driveshaft 27 connected, for example, to turbine or propeller systems of aircraft or the like (not shown). The tubular shaft 26 may be supported for rotation on bearings 29 as are generally understood in the art to rotate about axis 20.

A rotor shell 28 is positioned concentrically around the shaft 26 and held for co-rotation with the shaft 26 by a set of thermally insulated spokes 30 radiating outwardly from the shaft 26 as discussed in the above cited patents. The rotor shell 28 may be a substantially cylindrical tube, for example, of aluminum or other lightweight material, to have low weight and low moment of inertia. Opposite ends of the rotor shell 28 may be necked in slightly inward for improved structural rigidity. The rotor shell 28 will typically have a radial thickness of less than 100th of the radius of the shell 28 from the axis 20.

An outer surface of the rotor shell 28 includes a set of rotor coils 32 also having an elongate racetrack shape with a longest dimension extending between axial ends of the rotor shell 28. The rotor coils 32 will be spaced circumferentially around the rotor shell 28 at equal angular intervals and may be air-core planar coils, the latter term, as used herein, meaning that the coils are substantially two-dimensional being wound helically in one or a limited number of layers to conform to a surface that is not necessarily but may be planar. Generally, the rotor coils 32 will be high temperature superconductive materials so as to sustain a strong magnetic field without significant power consumption in the manner of a permanent magnet but with much lower mass and hence weight.

The stator coils 18 and rotor coils 32 may be integrated with sensors, for example, strain and temperature sensors, that may be wirelessly monitored, for example, to detect quenching or imminent failure.

Referring still to FIGS. 1, a cylindrical vacuum envelope 34 closely surrounds the stator shell 28 and includes end caps 36a and 36b providing bases to the cylinder and sealing the ends of the vacuum envelope 34 against the outer circumference of the shaft 26 to provide an airtight volume 38 that may be evacuated to reduce convective heat loss between the shell 28 and outside structures of the motor and between the shell 28 and the shaft 26.

Positioned within the cylindrical vacuum envelope 34 is an outer heatshield 40 being generally cylindrical in shape and sized to fit between the inner wall of the vacuum envelope 34 and the outermost extent of the rotor 24 while being spaced from both. Also positioned within the cylindrical vacuum envelope 34 but inside of the rotor shell 28 is a co-rotating inner heatshield 42 also being generally cylindrical in shape and sized to be spaced away from the inner surface of the rotor shell 28 without thermal contact.

Both the outer heatshield 40 and inner heatshield 42 may be attached to circular end plates 44a and 44b having an outer periphery conforming to the circumference of the outer heatshield 40 and extending radially inwardly about the shaft 26 to an opening 46 surrounding and spaced away from the shaft 26.

The outer heatshield 40 and inner heatshield 42 are desirably constructed of a material that is reflective in the far infrared and may be metal such as aluminum or copper, for example, polished to a mirror finish for this purpose. In one nonlimiting example, the material may have a emissivity in the infrared range of 8 to 14 μm of less than 0.1.

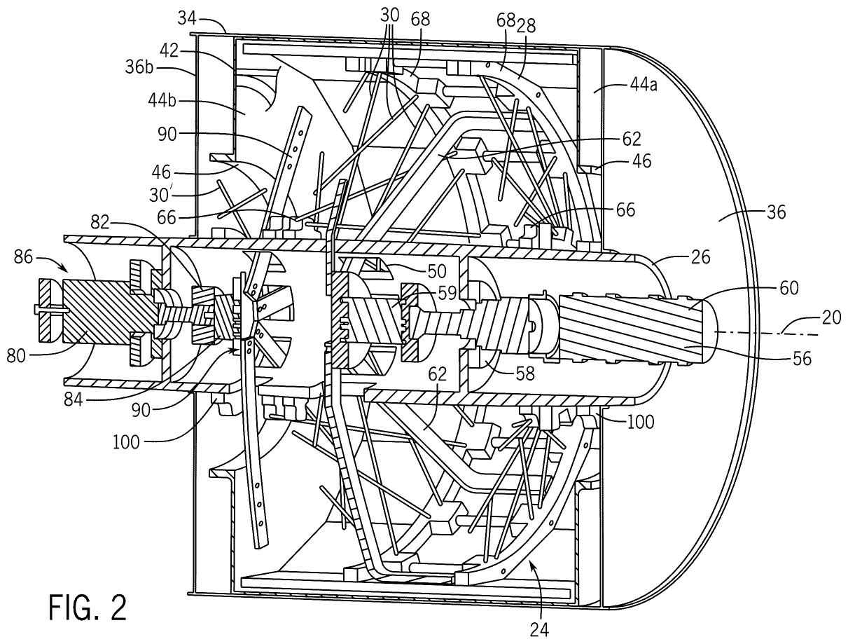

Referring now to FIG. 2, as described in greater detail in US patent applications 2022/0302816 and 2024/0014709 cited above, a cryocooler 56 may extend along the axis 20 with its cold end 58 passing into the hollow tubular shaft 26 to be roughly centered within the ends of the shell 28 and attached to the shaft 26. A hot end 60 of the cryocooler 56 may extend outside of the vacuum envelope 34 to receive electrical power to drive an internal sterling cycle heat pump pumping heat from the cold end 58 to the hot end 60 (at ambient temperatures) to bring the temperature of the cold end 58 to cryogenic temperatures of less than 50° Kelvin. Cryocoolers 56 suitable for use with the present invention are commercially available, for example, from the Sunpower Division of AMTEK of Berwyn, Pennsylvania, under the trade name CryoTel GT.

The cold end 58 of the cryocooler 56 may attach through compliant thermal conductors 59 to a set of thermally conductive straps 62. These compliant thermal conductors 59 are described in more detail in co-pending provisional application 63/648,274 filed May 16, 2024, and hereby incorporated by reference. The thermally conductive straps 62 extend radially at equal angles about the cold end 58 to be thermally connected to the inner surface of the rotor shell 28 and serving to draw heat from the motor coils to the cold end 58. Generally, the conductive straps 62 pass through openings 50 in the shaft 26 to be thermally insulated therefrom and may pass through corresponding holes 48 in the inner shield 42 (shown in FIG. 1). The material of the conductive straps 62 may, for example, be a conductive metal such as copper and may be flexible to accommodate thermal contractions during cool down of the rotor shell 28 but sufficiently rigid to suspend and locate themselves within the shaft 26 without contact with the shaft 26. Operation of the cryocooler 56 brings the rotor coils 32 down to cryogenic temperatures of less than 50K suitable for providing superconductivity in the coils 32, or temperatures of less than 77° Kelvin suitable for high temperature superconductivity.

A second cryocooler 80 of similar design to cryocooler 56 but acceptably having a lower heat capacity may extend along the axis 20 into the shaft 26 from the opposite direction of cryocooler 56 to have a cold end 82 passing into the hollow tubular shaft 26 to rotate therewith and to be within the radially opposed ends of the inner shield 42 and attached to the thermally conductive straps 90 by compliant thermal conductors 84 similar to compliant thermal conductors 59. A hot end 86 of the cryocooler 56 may extend outside of the vacuum envelope 34 to receive power to drive an internal sterling cycle heat pump pumping heat from the cold end 82 to the hot end 86 (at ambient temperatures) to bring the temperature of the cold end 58 to cryogenic temperatures of less than 50° Kelvin.

The thermally conductive straps 90 extend radially at equal angles about the cold end 82 to be thermally connected to the end plate 44b and thus to heatshields 40 and 42 and serve to draw heat from those heatshields to the cold end 58.

Referring still to FIG. 2, the rotor shell 28 may be attached to the shaft 26 by means of spokes 30. Inner ends of the spokes 30 may attach at one and two axially-spaced, circumferential spoke terminal ring 66 on the shaft 26 and then extend tangentially therefrom for maximum torsion resistance and reduced tensile forces. The outer ends of the spokes 30 attach to radially inwardly extending support ribs 68 attached to and passing axially along the inside of the rotor shell 28. The spokes 30 are angled in opposite directions (clockwise and counterclockwise) away from axially-extending and radially-extending planes through the shaft 26 and the inner shield 42 without thermal contact.

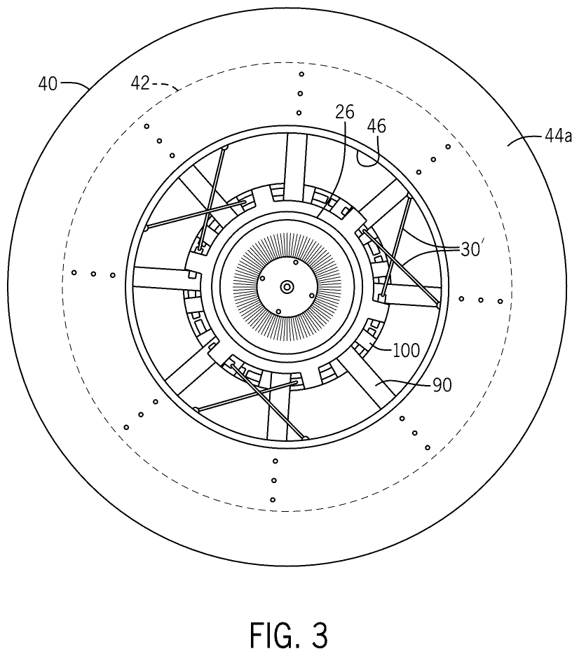

Referring now to FIG. 3, similar spokes 30′ may attach to axially-spaced, circumferential spoke terminal ring 100 attached to the shaft 26. Each spoke terminal ring 100 provides a radially-extending flange holding one end of the spokes 30′. As with the spoke terminal ring 66, the spoke terminal ring 100 may incorporate adjustment mechanisms for adjusting the length of the spokes 30′. The outer ends of the spokes 30′ attach to radially inwardly facing flange 102 on the opening 46. Again, the spokes 30′ are angled in opposite directions (clockwise and counterclockwise) away from axially-extending and radially-extending planes through the shaft 26. The much shorter length of the spokes 30′ with respect to the spokes 30 reduces thermal expansion effects in the spokes 30′.

The spokes 30 and 30′ provide a low thermal conductance as a result of a limited cross-sectional area of the spokes and the use of high tensile strength, low thermal conductivity materials such as Kevlar™ (Poly (azanediyl-1,4-phenyleneazanediylterephthaloyl), nylon, polyethylene, or the like including materials generally having a Young's modulus of no less than substantially 70 GPa and a thermal conductivity of less than 2 W/mK or less than 0.5 W/m-k in some embodiments. In some embodiments, the material of the spokes 30 will be a polymer and not a metal; however, metals including stainless steel and titanium alloys may also be practical. The invention also contemplates material such as carbon fiber and glass fiber composites. Importantly, the spokes 30 should have a high yield strength to thermal conductivity, for example, greater than

$$10 , 000 , 000 \frac{{σ}_{y s}}{k} ,$$

where σ_{ys} is measured in MPa and K as W/m/k. It will be understood that the spokes 30 30′ are generally flexible but provide rigid connection between the shaft 26 and shell 28 or heatshields 40 and 42 by means of tension which may be set to accommodate contraction of the shell 28 after assembly and cooling to cryogenic temperatures. Generally, the spokes 30 and 30′ will be flexible, for example, and bend by more than 20° when held horizontally at one end and extending horizontally over distance of 1 m.

During manufacture, the spokes 30 and 30′ may be preloaded statically to less than half of their yield stress so that they have capacity to resist torsion during use. This pre-tensioning is in part achieved by the cool down of the rotor shell 28 which may be calculated and used for this purpose in determining the static tensioning.

The inventors contemplate that the cryocoolers 56 and 80 may alternatively or in addition employ the concentric design of U.S. patent application Ser. No. 19/047,701 filed Feb. 7, 2025 and hereby incorporated by reference, this design allows both cryocoolers 56 and 80 to be installed from the same end of the shaft 26 or multiple (2, 3, 4 or more) cryocoolers to be installed with some coaxial pairs to variously serve the heatshields 40 and/or 42 or the rotor coils 32. The inventors also contemplate that in some cases the heat shield 40 and/or 42 may be passive without cryocoolers.

While generally, it is contemplated that the spokes 30 may be a uniform material uninterrupted in their communication between the rotor shell 28 and other supporting structure, it will be appreciated that composite or multipart spokes 30 may also be used, for example, having different materials along their length, for example, a material with higher thermal conductivity interrupted by short intervals of thermally blocking material or the like, and thus that the bulk properties of the spokes 30 must be considered with respect to the limitations and designs described herein.

While the above description is generally focused on the construction of a motor, it will be appreciated that the same principles will produce an electrical generator and thus the invention generally involves an electrical machine rather than a motor or generator particularly.

Certain terminology is used herein for purposes of reference only and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A superconducting machine comprising:
a stator; and
a rotor having a central shaft rotatably mounted with respect to the stator to allow the rotor to rotate about a shaft axis with respect to a stator, wherein the rotor includes:
a rotor shell attached to and thermally isolated from the shaft
a set of superconducting windings positioned on the rotor shell; and
a heatshield positioned outside and surrounding the rotor shell to block radiative heat transfer and supported by and isolated from the shaft by a plurality of tensioned flexible spokes.

2. The superconducting machine of claim 1 the rotor shell is also suspended about the shaft by a second plurality of tensioned flexible spokes disjoint with tensioned flexible spokes supporting the heatshield.

3. The superconducting machine of claim 1 wherein including a vacuum vessel enclosing the rotor shell in an airtight volume sealed against the central shaft.

4. The superconducting machine of claim 1 wherein the heatshield is polished metal.

5. The superconducting machine of claim 1 wherein the heatshield provides a tubular extent along a length of the rotor shell received by end caps extending radially inwardly toward the central shaft to an opening surrounding but spaced from the central shaft; and wherein the second e plurality of tensioned flexible spokes are positioned between the opening and the central shaft.

6. The superconducting machine of claim 5 further including a second heatshield positioned inside the rotor shell surrounding the shaft to block radiative heat transfer and supported on the end caps.

7. The superconducting machine of claim 1 further including a first cryocooler communicating along the first conductive path with the rotor shell and a second cryocooler communicating along a second conductive path with the heatshield.

8. The superconducting machine of claim 7 wherein the first and second cryo-coolers are mounted coaxially with the central shaft.

9. The superconducting machine of claim 8 wherein the first and second cryo-coolers are mounted coaxially at opposite ends of the central shaft.

10. The superconducting motor of claim 1 wherein the spokes are polymer material.

11. The superconducting machine of claim 10 wherein the spokes are composed of a material chemically identical to materials selected from the group consisting of Kevlar™, Mylar™, and Kapton™.

12. The superconducting machine of claim 1 wherein the heatshield is substantially cylindrical and centered on a rotational axis of the central shaft.
